(19) United States
(12) Patent Application Publication
(10) Pub. No.: US 2009/0105963 A1
(43) Pub. Date: Apr. 23, 2009

(54) Methods for Flow Cytometry Analyses of Un-Lysed Cells from Biological Fluids

(76) Inventors: Jesper Laursen, Allerod (DK); Ian Storie, Madonas Rajons (LV)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/300,342

(22) PCT Filed: May 11, 2007
(86) PCT No.: PCT/DK07/00225

§ 371 Date: Nov. 11, 2008

Related U.S. Application Data
(60) Provisional application No. 60/800,173, filed on May 13, 2006.

(51) Int. Cl. G06F 19/00

(52) U.S. Cl. 702/21

(57) ABSTRACT

A method for analyzing a pathological deviation of at least one white blood cell population from a normal level in an un-lysed blood sample, comprising the steps of counting, with a flow cytometer, a number, n₁, of white blood cells expressing a first marker; a number, n₂, of white blood cells expressing a second marker, and a number, n₃, of white blood cells expressing a third marker but not the first marker; and comparing the sum (n₁+n₂+n₃) with a reference value. The sum (n₁+n₂+n₃) may represent the number of lymphocytes. The first, second and third markers may be chosen from the group consisting of CD56, CD3 and CD19.

### TECHNICAL FIELD

The present invention relates to methods for enumerating cell populations in biological samples that have not been subjected to a lysing treatment. In one aspect, the invention relates to the use of gating strategies for analysis of antibody stained whole non-lysed human by flow cytometry. This application incorporates by reference herein, in its entirety, U.S. provisional application 60/800,173, filed on 13-May, 2006 and titled “Methods for flow cytometry analyses of white blood cells from whole un-lysed blood samples.”

### BACKGROUND ART

Counting the number and types of cells in a blood sample has been and continues to be an important diagnostic tool. Both the absolute and relative numbers of various blood cell types can be useful for guiding diagnoses of diseases and for monitoring the course of disease progression or effectiveness of treatment. As one well-known example, determining the number of white blood cells (or leukocytes) in a blood sample can provide an indication of infection or of Leukemia. The determination of the populations, either absolute or relative, of specialized white blood cells, such as T-helper cells can provide important diagnostic information related to other disease conditions.

Normal blood cell counts generally fall within various reference ranges as outlined in Table 1. Deviations from one or more of the “normal” ranges shown in Table 1 can be pathological, that is, indicative of or relating to a disease condition. Since white blood cells are intimately related to natural immune defenses, the quantification of white cells and various subsets of the white blood population can be especially critical. As but one example, an increase in lymphocytes to greater than 4000 per microliter (lymphocytosis) is usually a sign of a viral infection, including glandular fever, but it may also be seen with intracellular bacterial infections, such as in tuberculosis and in many leukemias.

Frequently, quantification of certain subsets of the lymphocyte population, rather than the entire population itself, provide diagnostic information. For instance, it is well known that the Human immunodeficiency virus (HIV) infects and ultimately destroys cells that present CD4 on their surface, including CD4+ T-cells, which are required for the proper functioning of the immune system. Therefore, analysis of the ratio of CD4+ T-cells to other T-cells, such as CD8+ cells, or to other lymphocytes, can provide important information on the progression of AIDS. As another example, quantification of antigen specific T cells is important for measurement of and monitoring patients T cell responses to pathogens, autoantigens and tumor-derived antigens as well as for identification of transplanted patients at risk for viral infection (Heijnen IAFM et al. “Enumeration of Antigen-Specific CD8+ T Lymphocytes by Single-Platform, HLA Tetramer-Based Flow Cytometry: A European Multicenter Evaluation.” Cytometry Part B (clinical cytometry) 62B:1-13, 2004).

TABLE 1

| | |
|---|---|
| Red blood cell counts | |
| Male | 4.5-6.5 × 10¹²/L |
| Female | 3.8-5.8 × 10¹²/L |
| Reticulocytes | 10-100 × 10⁹/L |
| White blood cell counts | |
| Total white blood cells | 4.0-11.0 × 10⁹/L |
| Neutrophil granulocytes | 2.0-7.5 × 10⁸/L (45%-74%) |
| Lymphocytes | 1.0-4.0 × 10⁹/L (16%-45%) |
| Monocytes | 0.0-0.8 × 10⁹/L (4%-10%) |
| Eosinophil granulocytes | 0.0-0.5 × 10⁹/L (0%-7%) |
| Basophil granulocytes | 0.0-0.2 × 10⁹/L (0%-2%) |

Immune phenotyping of human cells, including blood cells, typically includes binding of fluorochrome labelled antibodies to specific targets—antigens—and subsequent analysis of the resulting selectively labelled cells by a flow cytometer. The obtained color code for each cell then allows for assignment of the antigens present on or within that cell.

Flow cytometry comprises a well known methodology for identifying and distinguishing between different cell types in a non-homogeneous sample. The general principles of its use of and construction of flow cytometers are described U.S. Pat. Nos. 4,727,020, 4,704,891 and 4,599,307 incorporated herein by reference.

The flow cytometry sample may be drawn from a variety of sources such as blood, lymph, urine, or may be derived from suspensions of cells from solid tissues such as brain, kidney or liver. In the flow cytometer, cells, often combined with reagent or buffer solutions, are passed substantially one at a time through one or more sensing regions where each cell is illuminated by one or more energy sources. Generally, each cell within the flow cell interrupts a focused light source wherein the light is scattered and absorbed (or fluoresced), thus establishing a single unique cell interrogation event. Upon such interrogation, light emitted or scattered by a cell may be detected by one or more photodetectors and used for either sorting or analytical purposes. Alternatively, if the light scattering or emission characteristics of certain cells do not meet certain pre-determined threshold (e.g., trigger) criteria, the data for those cells may not be stored in permanent memory. Either data acquisition or data storage or both may be triggered for a cell when the sensed scattering or emission characteristics meet or surpass the threshold or trigger value. Generally, in the analysis of blood counts, forward scattered light is used to provide information on cell size and side scatter is used to provide information on cell structure. Further, the fluorescence from various fluorochrome-labelled binding molecules, such as monoclonal antibodies, may be used to detect the presence of cells having particular distinctive cell membrane markers.

The characteristics of the detected light that is scattered and emitted from the cells as the pass through the sensing region may be used as a basis for automatic sorting decisions within a flow cytometer sorter instrument. Alternatively, the detected scattered and/or emitted light may, for certain automatically selected events matching some pre-determined trigger criteria, be stored in computer memory for later offline analysis. The stored data are generally in a format known as “list mode” in which the data collected for each cell comprises a “recorded event” comprising several parameters. The stored list mode data comprises a data value for each measured parameter relating to the first detected cell, to the second detected cell, and to each subsequently detected cell, in the sequence obtained, up until the data for the final detected cell. The stored parameters for each cell generally relate to the level of detection of light scattered by the cell or light emitted from the cell within certain wavelength bands of interest.

In general, the emitted light that is detected in a flow cytometer analyzer can provide information relating to distinctive spectral signatures of cells as they pass through the sensing region. The number of detection events for each of the various distinctive spectral signatures is then related to the number of cells associated with each such signature. Most often, these distinctive spectral signatures are derived from fluorescence from chemical labels that bind to particular respective cell types, i.e., from fluorochromes conjugated to antibodies that bind only to particular respective cell markers. However, depending upon the user's particular applications and needs, the spectral signatures need not be limited to fluorescence intensity signals, but may include any known type of spectral signature, such as, for instance, fluorescence decay time, UV-visible optical absorption, infrared absorption, reflectance or emission, spontaneous, surface enhanced and resonance Raman scattering, etc.

The data contained within a list mode file based on n cytometrically determined parameters generally defines clusters of cells, within an n-dimensional analytical space, having particular scattering or emission properties. The process of analytically discriminating among and between cells having differing spectral characteristics and separating the cells into different populations based upon these characteristics is known as gating. By a combination of graphical and statistical analysis, partial discriminations and selection of data subsets may be made based upon fewer than the full set of parameters, using projections of the data onto graphs illustrating the distribution of spectral characteristics within restricted subspaces. The resulting data subsets may then be separately analyzed, either statistically or graphically, using the values of the remaining or other parameters. For instance, by plotting orthogonal light scatter versus forward light scatter in either real time or by reanalysis of the data after the events have been recorded, one can distinguish between and count, for example, the granulocytes, monocytes and lymphocytes in a population of leukocyte. By gating on only lymphocytes, for example, using light scatter and by the use of appropriate immunofluorescence markers, such as monoclonal antibodies labelled with fluorochromes of different emission wavelength one can further distinguish between and count cell types within the lymphocyte population (e.g., between CD4+ and CD8+ lymphocytes).

Malignancies of B Cells are investigated extensively by flow cytometry and an important question is if a clonal development is occurring. Clonality is investigated using antibodies against surface immunoglobulins. Each B Cell either expresses kappa or lambda light chains and the normal ratio is 60% kappa positive cells and 40% lambda positive cells. Deviation from this ratio is indicative of malignant development. There is, however, a significant amount of free immunoglobulin in plasma and other body fluids.

There are three main categories flow cytometric techniques for enumeration of absolute counts (per volume) of white blood cells. These categories consist of either the broad category encompassing the so-called “dual-platform” methods or else one of two categories of so-called “single-platform” methods.

In the various dual-platform methods, relative counts of species or subspecies of white blood cells are determined in a flow cytometer, using either cell scattering properties or detection of fluorescently labelled cell markers. The species or subspecies in greater amount is generally a reference cell type or group (such as, for instance all white blood cells) whose absolute count, per unit volume is independently measured with a separate counting instrument, such as a haematology analyzer. The absolute count of the other species or subspecies, generally present in lesser amount, is then calculated as the product of the ratio determined by flow cytometry and the absolute count of the reference determined by the second instrument.

In the most commonly used method, the single-platform method, counting beads are added, in a known concentration, to the blood sample and counted in the flow cytometer together with blood cells. The absolute count of blood cells is then calculated as the product of the cell-to-bead count ratio and the concentration of counting beads. In a second single-platform method, the rate of sample fluid volumetric withdrawal from a chamber and passing through a flow cytometer is derived, simultaneous with cell counting. The rate of fluid withdrawal is determined from signals indicating passage of the fluid meniscus past each of two electrodes within the sample chamber, the positions of the electrodes being set so as to correspond to a known volume. The cell concentration may then be determined as the count measured during the time in which the meniscus is between the two electrodes divided by the predetermined volume.

Often, preparation of samples—including blood as well as other biological fluids or suspensions of cells—for flow cytometry includes a lysing step that selectively bursts a population of unwanted cells while leaving the cells of interest intact. For instance, blood samples for white-blood-cell analysis according to any of the above counting techniques are prepared according to a protocol that includes lysis of erythrocytes while allowing most of the white blood cells intact. The lysing of unwanted cells helps to reduce the overall degree of light scattering in a subsequent flow cytometer analysis or sorting procedure. As a first example, the so-called lyse/no-wash (LNW) assay typically requires approximately fifteen minutes incubation time followed by an additional fifteen minutes of lyse reaction time, after which the analysis is performed. As a second example, the so-called lyse/wash (LW) assay typically requires the same fifteen minutes incubation time and fifteen minutes of lyse reaction time as well as an additional 10-20 minute wash procedure prior to commencing the analysis. By contrast, the less-utilized no-lyse (NL) techniques, which leave erythrocytes intact, generally only require approximately fifteen minutes of reaction time.

In some situations, it is desirable to do a wash step during sample preparation, even though the cells are not lysed. For instance, as mentioned above, investigation of B-Cell clonality requires identifying immunoglobulins on cell surfaces. Yet, a significant amount of free immunoglobulin exists in plasma and other body fluids and may interfere with the measurements. It is therefore necessary to wash the cells before an immunophenotyping for kappa or lambda clonality can be performed. It is possible to use the no-lyse method in this scenario; unlysed blood or fluid is washed with a non-lysing solution such as PBS. Typically the sample fluid is washed with 100-500 times the volume at least once before it is stained with relevant reagents. The no-lyse method therefore both saves time and is gentler to the cells in the sample than the traditional lyse/wash method.

As illustrated above, the no-lyse assay techniques can, in many situations, double the sample throughput at the preparation stage. To save time in the sample preparation procedure, it is therefore advantageous to eliminate the lysing step. There are three main benefits with this approach from a work flow perspective: 1) the sample preparation time is lowered, 2) the cost of lysing reagent is eliminated and 3) the acquisition rate of the sample can be increased.

Although lysing sample preparation protocols are well established, the lysing procedure can cause bursting of cells of interest, which must be maintained intact in order to be counted in a flow cytometer. This can be problematical in a clinical setting in which a large number of samples of biological fluids or suspensions are screened in order to detect rare cells indicative of disease, such as Minimal Residual Disease in remissive cancer patients. Furthermore, selective lysing of cells of interest can cause changes in relative cell populations, e.g., changes in white blood cell populations, thereby distorting cell count ratios. In the analysis of blood, in spite of efforts by those in the art to design reagents that lyse red blood cells while not affecting other cell types in the sample, occasional lysis of the white blood cells and other unwanted effects may still occur, thereby leading to under-counting the white cells to be analyzed. Furthermore, it has been shown that lysing can selectively attack different sub-populations white blood cells, thereby causing difficulties in not only absolute counting, but also relative counting. By contrast, the lack of a harsh lysing procedure in the no-lyse techniques leaves the cell sample in a more natural condition that may be beneficial for some fragile cell types. Also, this may be an advantage for sorting purposes of intact and vigilant cells in a flow cytometer sorter.

When whole unlysed blood is run on a flow cytometer the high number of particles in the sample causes a high increase in scatter. Indeed, the inventors have determined that, when the flow rate through a flow cell is increased to greater than about 150 μl per minute, the overall variation in the measured scatter increases to the extent that it becomes difficult to distinguish between various cell populations using any gating strategy that relies, either in whole or in part, on scatter. An illustration of this effect is provided in FIGS. 5-6, which show the increasing overlap between cell populations on event plots taken from sets of experiments in which the only difference was the sample flow rate. Interestingly, this effect is observed in samples prepared by both the LNW and NL techniques. It is therefore of importance to be able to develop strategies for analysing the acquired data from such samples that does not rely on scatter.

Regardless of exactly how cell analyses are reported, it is important, for the benefit of clinical throughput and efficiency, to be able to enumerate even rare events in the shortest possible time without sacrificing statistical accuracy. A clinical laboratory may have a workload of hundreds of blood samples per day to be analyzed and only one flow cytometer available for analysis. Given the overhead time requirements relating to sample changing, instrument calibration, etc., this type of workload demands that individual sample analyses consume, at most, a few minutes of time each. However, from the data of Table 1, it may be readily observed that a single micro-liter of “normal” whole unlysed blood will comprise approximately four million cells, of which approximately 4000 will be white blood cells. Out of these white blood cells, roughly 2100 will comprise neutrophil granulocytes and roughly 1450 will comprise lymphocytes. The remaining approximately 450 white blood cells will comprise a mixture of monocytes, eosinophil granulocytes and basophil granulocytes.

The numbers may be even lower for specialized cells, such as antigen-specific T-cells, or for cells in samples obtained from patients having pathological blood cell deficiencies. If blood cell species are to be ratioed against one another, then, to obtain adequate counting statistics (i.e., to be able to calculate the ratio with a precision of at least 10%), the blood cell species count used as the numerator should be on the order of at least one hundred, and the blood cell species count used as the denominator should be on the order of at least several hundreds to thousands. Thus, the cytometer flow rate and detection electronics, and, optionally, sorting electronics, must be suffiently fast and sufficiently sensitive so as to be able to handle, potentially, 107 blood cell interrogation events may occur within the time span of a few minutes. If roughly five minutes is allotted per sample, on average, this requires a flow cytometer analyzer or sorter capable of potentially detecting at least 30000 events per second.

### SUMMARY OF INVENTION

With the capability of identifying, quantifying or sorting cells from the blood of patients or from other biological fluids or cell suspensions without the need for methods such as application of lysing reagents that may harm or change the cells, the high-speed no-lyse analysis methods disclosed herein provides a means for efficient counting or purification of functional cells and for high-speed analysis or clinical screening for various cell characteristics. Such purified cells may both be used for research purposes, diagnostics as well as for treatment. Purification of unperturbed cells may also be a pre-requisite for efficient and reliable ex-vivo expansion of antigen specific T cells.

Therefore, in order to overcome some of the above described disadvantages and problems of prior art white blood cell flow cytometric analyses, we herein disclose improved methods for flow cytometry analyses of white blood cells from whole un-lysed blood samples. A first object of the invention is to provide statistically precise methods for flow cytometry analyses of white blood cells that are associated with sample preparation times that are less than half those of traditional lyse/wash and lyse/no-wash procedures. A further object of the present invention is to develop methods for analysing flow cytometry acquired data of un-lysed blood samples that do not rely on scatter. A major advantage of the strategies elucidated herein is to eliminate unwanted events (noise) from the events/population of interest to both enhance the possibility of finding it in the first place but also to obtain a correct immune phenotype of such a population without the use of scatter properties of the cells.

In one aspect, the invention may comprise a method for analyzing a pathological deviation of at least one white blood cell population from a normal level in an un-lysed blood sample, comprising:

counting, with a flow cytometer, a number, n₁, of white blood cells expressing a first marker;

counting, with the flow cytometer, a number, n₂, of white blood cells expressing a second marker;

counting, with the flow cytometer, a number, n₃, of white blood cells expressing a third marker and not expressing the first marker; and

comparing the sum (n₁+n₂+n₃) with a reference value.

In a second aspect, the invention may comprise a method for analyzing a pathological deviation of at least one white blood cell population from a normal level in an un-lysed blood sample, comprising:

counting, with a flow cytometer, a number, n₁, of white blood cells expressing a first marker;

counting, with the flow cytometer, a number, n₂, of white blood cells expressing a second marker;

counting, with the flow cytometer, a number, n₃, of white blood cells expressing a third marker and not expressing the first marker;

counting, with the flow cytometer, at least one other number, nₒ, each such other number being the number of white blood cells expressing a different respective marker, the set of all such other numbers being indexed as nₒᵢ, (4≦i≦N) for some maximum number N; and

comparing the quantity

$$( {n}_{1} + {n}_{2} + {n}_{3} - {{\sum }^{N}}_{4} {n}_{oi} )$$

with a reference value.

In a third aspect, the invention may comprise a single-platform method for analyzing a pathological deviation of the number of lymphocytes per liter from a normal level in an un-lysed blood sample, comprising:

counting, with a flow cytometer, a number, n₁, of cells expressing CD56 but not CD3;

counting, with the flow cytometer, a number, n₂, of cells expressing CD3;

counting, with the flow cytometer, a number, n₃, of cells expressing CD19;

counting, with the flow cytometer, a number, n₄, of counting beads;

calculating the number of lymphocytes counted as the sum of n₁, n₂ and n₃; and

correcting the number of lymphocytes counted to the number of lymphocytes per liter of blood using the measured number n₄ and a known concentration of the counting beads.

In a fourth aspect, the invention may comprise single-platform method for analyzing a pathological deviation of the number of lymphocytes per liter from a normal level in an un-lysed blood sample, comprising:

counting, with a flow cytometer, a number, n₁, of cells expressing CD56 but not CD3;

counting, with the flow cytometer, a number, n₂, of cells expressing CD3;

counting, with the flow cytometer, a number, n₃, of cells expressing CD19;

counting, with the flow cytometer, a number, n₄, of counting beads;

counting, with the flow cytometer, a number, n₅, of cells expressing CD14;

counting, with the flow cytometer, a number, n₆, of cells expressing CD15;

calculating the number of lymphocytes counted as the quantity (n₁+n₂+n₃)−(n₅+n₆); and

correcting the number of lymphocytes counted to the number of lymphocytes per liter of blood using the measured number n₄ and a known concentration of the counting beads.

In a fifth aspect, the invention may comprise, system for sorting at least one white blood cell population from un-lysed blood sample to an output, comprising:
a flow cytometer sorter configured to derive data from emissions from each one of various individual blood cells of the sample, the data comprising:
   a first data value relating to a first emission, the first emission relating to the presence of a first marker in the individual blood cell;
   a second data value relating to a second emission, the second emission relating to the presence of a second marker in the individual blood cell; and
   a third data value relating to the presence of a third emission, the third emission relating the presence of a third marker in the individual blood cell; and
a computer in communication with the flow cytometer sorter configured to receive the first, second and third data values, to evaluate a Boolean expression with reference to the first, second and third data values and to issue a sorting command to the flow cytometer based on the evaluation.

In sixth aspect, the invention may comprise a method for sorting at least one white blood cell population from un-lysed blood sample to an output, comprising:
providing a flow cytometer sorter configured to derive data from emissions from each one of various individual blood cells of the sample, the data comprising:
   a first data value relating to a first emission, the first emission relating to the presence of a first marker in the individual blood cell;
   a second data value relating to a second emission, the second emission relating to the presence of a second marker in the individual blood cell; and
   a third data value relating to the presence of a third emission, the third emission relating the presence of a third marker in the individual blood cell; and
providing a computer in communication with the flow cytometer sorter configured to receive the first, second and third data values, to evaluate a Boolean expression with reference to the first, second and third data values and to issue a sorting command to the flow cytometer based on the evaluation.

### BRIEF DESCRIPTION OF DRAWINGS

FIG. 1 is a hypothetical Venn diagram illustrating the distribution of various white cell populations from the hypothetical distribution for a hypothetical sample exhibiting good separation of the spectroscopic signals from the applied markers, CD19, CD3, CD56.

FIG. 2 is a hypothetical Venn diagram illustrating the distribution of various white cell populations for a hypothetical sample in which the determined lymphocyte population as given by the logical gate: [CD3+ or CD56+ or CD19+] is contaminated with a an overlapping population of monocytes due to problems with threshold setting.

FIG. 3 is a hypothetical Venn diagram illustrating the distribution of various white cell populations for a hypothetical sample in which the determined lymphocyte population as given by the logical gate: [CD3+ or CD56+ or CD19+] is contaminated with a an overlapping population of granulocytes due to problems with threshold setting.

FIG. 4A is a plot of the distribution of event intensities showing intensities of CD45-CY fluorescence plotted versus side scatter (SS) for an unlysed blood sample as determined from a flow cytometer analyzer.

FIG. 4B is a plot of the distribution of event intensities showing intensities of CD4-PE-Cy5 plotted versus CD14/CD15-FITC as determined from a flow cytometer analyzer for the unlysed blood sample of FIG. 4A and showing a monocyte/granulyte exclusion gate.

FIG. 4C is a plot of the distribution of event intensities showing intensities of CD19-PE-Texas Red plotted versus CD3-APC-Cy7 as determined from a flow cytometer analyzer for the unlysed blood sample of FIG. 4A after application of the monocyte/granulyte exclusion gate of FIG. 4B and showing a gate for B-lymphocytes and a gate for T Lymphocytes.

FIG. 4D is a plot of the distribution of event intensities showing intensities CD3-APC-Cy7 plotted versus CD56-PE as determined from a flow cytometer analyzer for the unlysed blood sample of FIG. 4A after application of the monocyte/granulyte exclusion gate of FIG. 4B and showing a gate for NK-lymphocytes.

FIG. 4E is a plot of the distribution of event intensities showing intensities of CD3-APC-Cy7 versus CD56-PE as determined from a flow cytometer analyzer for the unlysed blood sample of FIG. 4A plotted without the application of any gates.

FIG. 4F is a plot of the distribution of event intensities showing CD14/CD15-FITC plotted versus CD19-PE-Texas Red showing a gate region for counting beads.

FIGS. 5A-5B are, respectively, event plots of forward scatter (FS) versus side scatter (SS) and of CD45-CY fluorescence versus side scatter as determined in a flow cytometry analysis of a blood sample prepared by the Lyse/No Wash technique and run through the analyzer at 100 μl/min.

FIGS. 5C-5D are, respectively, event plots of forward scatter (FS) versus side scatter (SS) and of CD45-CY fluorescence versus side scatter as determined in a flow cytometry analysis of a blood sample prepared by the Lyse/No Wash technique and run through the analyzer at 300 μl/min.

FIGS. 6A-6B are, respectively, event plots of forward scatter (FS) versus side scatter (SS) and of CD45-CY fluorescence versus side scatter as determined in a flow cytometry analysis of a blood sample prepared by the No Lyse technique and run through the analyzer at 100 μl/min.

FIG. 7 is a functional block diagram of a flow cytometer apparatus.

### MODES FOR CARRYING OUT THE INVENTION

Here we focus on a strategy for selection of lymphocytes, one of the three major white blood cell types (the other two are monocytes and granulocytes). The strategy makes it possible to obtain the percentage of subpopulations out of lymphocytes when it is used for analysis of properly labelled non-lysed human blood samples.

Before the present invention is described, it is to be understood that this invention is not limited to the particular embodiments described, as such methods, devices, and formulations may, of course, vary. It is also to be understood that the terminology used herein is for the purpose of describing particular embodiments only, and is not intended to limit the scope of the present invention which will be limited only by the appended claims. It must be noted that as used herein and in the appended claims, the singular forms “a,” “an,” and “the” include plural referents unless the context clearly dictates otherwise, and includes reference to equivalent steps and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some preferred embodiments of the methods and materials of the invention are described below. All publications mentioned herein are incorporated herein by reference to disclose and describe the specific methods and/or materials in connection with which the publications are cited.

In this document, the notation “CDn”, in which “n” is a variable integer, is used in its conventional sense to refer to one of many well-known “Clusters of Differentiation” or, more simply, “markers”, which are distinctive molecules disposed on cell surfaces, which may be recognized by specific sets of antibodies, and which may be used to identify the cell type, stage of differentiation and activity of a cell. Furthermore, the notation “CDn FF”, where “n” is a variable integer as before and where “FF” represents additional alphabetic characters, is used to denote a situation in which the marker CDn is detected by an antibody that is chemically bound to the reporter molecule (e.g., a fluorescent tag) denoted by the identifying symbol “FF”.

The notations CDn+ and CDn−, where “n” is an integer, refer to individual cells or, in the aggregate, to populations of cells that are, respectively, positive and negative for the marker CDn. The “+” symbol and designation as “positive” means that the signal intensity is above background, whereas the “−” symbol and “negative” designation means that the signal intensity is comparable to background. Background is either the signal from cells negative for the marker in the same sample or it is the signal originating from cells stained with a control reagent. In both cases the background signal originates from auto fluorescence and unspecific binding of the applied reagent (and instrument noise). Likewise, the notation CDn₁+CDn₂−, where n₁ and n₂ are different integers and n₁≠n₂, refers to a population of cells that is both positive for the marker n₁ and negative for the marker n₂. Further, a notation such as CDn_{bright} means that the signal intensity is strongly above background and a notation such as CDn_{dim} means that the signal intensity is low, but still above background. In flow cytometry, the terms “dim” and “bright” often refer to deviations of the signal levels from those of normal or average cells. As an example, lymphocytes are normally described as having a bright CD45 signal (because they express more CD45 than granulocytes and monocytes).

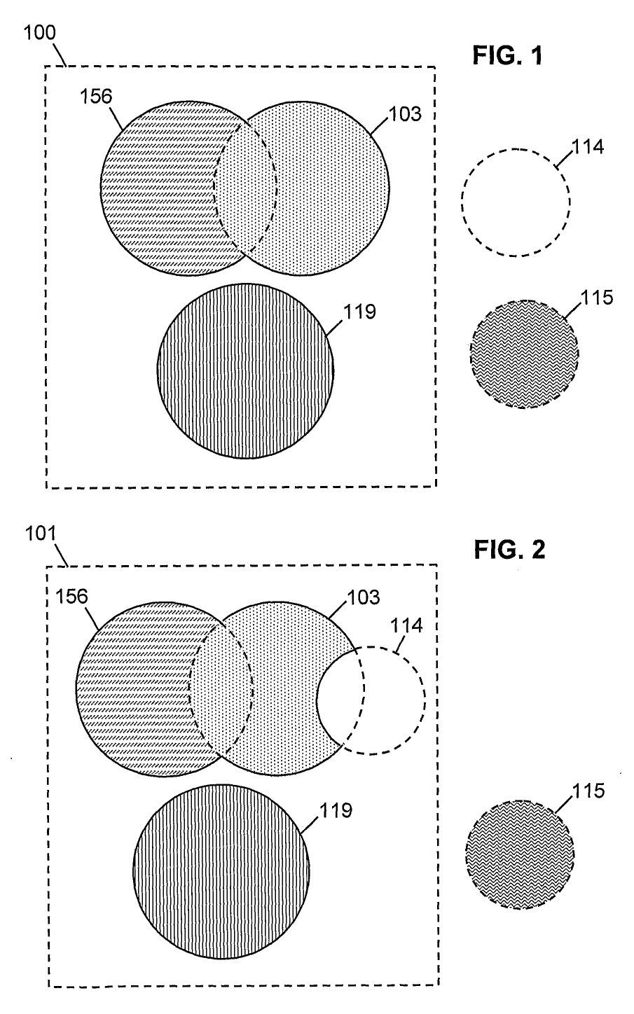

Traditionally lymphocytes are identified by either their combination of a low side scatter (SSC) and low forward scatter (FSC) or by high CD45 expression and low SSC. However, as noted above, the increased variation in measured scatter in the no-lyse (NL) sample preparation method, or at high flow rates in either the NL or lyse no-wash (LNW) sample preparation methods makes it desirable to develop an alternative gating strategy for lymphocyte enumeration. It is possible to identify the lymphocyte population by adding together the three populations that constitute them: CD56+CD3− NK cells, CD3+NK-like and T cells and CD19+ B Cells. Thus, the gate defined by the Boolean expression (CD56 OR CD3+ OR CD19+) (FIG. 1) is an efficient strategy for obtaining a gate that encompasses all lymphocytes, provided that there is no contamination of any of the CD56, CD3 or CD19 signals by non-lymphocyte cells, such as monocytes and granulocytes. [Note that, in this document, Boolean logical operators defining gates are indicated by both capitalization and underlining.]

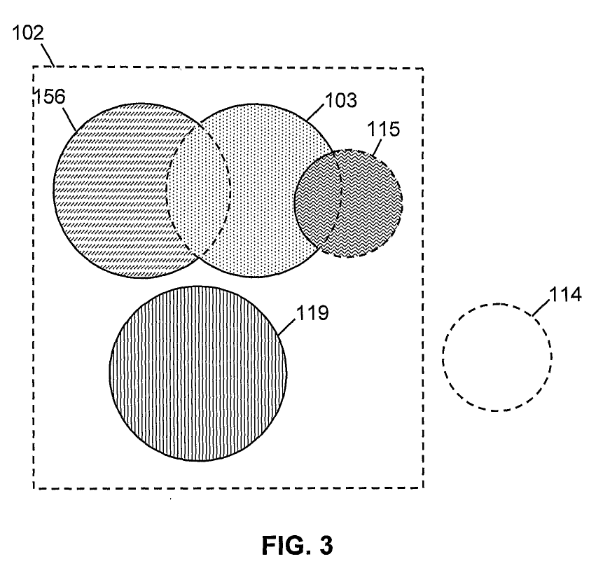

Table 2, below is a chart illustrating a hypothetical distribution of marker-positive (+) and marker-negative (−) events among various data bins (number of events per marker) as measured by five separate flow cytometer detectors for a hypothetical sample showing good separation of the spectroscopic signals from the applied markers, CD19, CD3, CD56. FIG. 1 is a hypothetical Venn diagram for an ideal situation (Table 2) in which the “OR-gate” CD56+CD3− OR CD3+ OR CD19+ adequately defines and distinguishes the lymphocytes without significant contamination from non-lymphocyte cells. In FIG. 1, as well as in FIGS. 2-3, the circle 156 represents CD56+ cells, the circle 103 represents CD3+ cells, the circle 119 represents CD19+ cells, the circle 114 represents CD14+ cells and the circle 115 represents CD15+ cells. The total lymphocytes (box 100) are determined as the population represented by circle 119 plus the population encompassed by the solid lines enveloping circles 156 and 103 (i.e., the overlap region between these two circles is considered only once). FIG. 1 illustrates that, in this situation, with good separation of the spectroscopic signals from the applied markers, the lymphocytes can be identified as cells positive for either CD19, CD3 or CD56.

TABLE 2

| | List File Data | | | | |
|---|---|---|---|---|---|
| | Detector 1 | Detector 2 | Detector 3 | Detector 4 | Detector 5 |
| | marker | | | | |
| Events | CD3 | CD56 | CD19 | CD14 | CD15 |
| 1-199 | − | − | − | − | + |
| 999-1049 | − | − | − | + | + |
| 1050-1099 | − | − | + | − | − |
| 1100-1149 | + | + | − | − | − |
| 1150-1199 | − | + | − | − | − |
| 1200-1400 | + | − | − | − | − |

Often the populations of monocytes may overlap with those of lymphocytes when plotted using the markers CD19, CD3 and CD56. In such a situation, there may be poorer separation of the spectroscopic signals from the applied lymphocyte markers (using only the markers CD19, CD3 and CD56) due to background signals (background staining or autofluorescence) from monocytes. Adding more markers for purifying the population of interest can further refine the strategy. Thus, by addition of a marker, such as CD14, for monocytes, one can eliminate those cells from the population of interest with the Boolean gate (CD56+ OR CD3+ OR CD19+ gate AND NOT CD14+), which is a combination of an “OR-gate with a NOT-gate”

Table 3 below is a chart illustrating a hypothetical distribution of marker-positive (+) and marker-negative (−) events among various data bins (number of events per marker) as measured by five separate flow cytometer detectors for a hypothetical sample in which the determined lymphocyte population as given by the logical gate: [CD3+ or CD56+ or CD19+] is contaminated with a an overlapping population of monocytes due to problems with threshold setting. FIG. 2 is a hypothetical Venn diagram that corresponds to Table 3 and which shows the exclusion of monocytes (circle 114) from subsequent counting and analysis. Lymphocytes can then be clearly identified as cells positive for either CD19, CD3 or CD56 but not CD14. In the hypothetical situation presented in Table 3 and FIG. 2, the background problems are in detector 1 could also have been in the detectors 2 and 3 or in combinations of or all of detectors 1, 2 and 3.

TABLE 3

| | List file data | | | | |
|---|---|---|---|---|---|
| | Detector 1 | Detector 2 | Detector 3 | Detector 4 | Detector 5 |
| | marker | | | | |
| Events | CD3 | CD56 | CD19 | CD14 | CD15 |
| 1-990 | − | − | − | − | + |
| 991-999 | + | − | − | + | − |
| 1000-1049 | − | − | − | + | + |
| 1050-1099 | − | − | + | − | − |
| 1100-1149 | + | + | − | − | − |
| 1150-1199 | − | + | − | − | − |
| 1200-1400 | + | − | − | − | − |

Similarly, the populations of granulocytes may overlap with those of lymphocytes when plotted using the markers CD19, CD3 and CD56, as schemiatically illustrated in Table 4 and FIG. 3. In this case, the granulocytes could be excluded from further analyses by a Boolean expression gate such as (CD56+ OR CD3+ OR CD19+ AND NOT CD15+). To aid graphical plotting and analysis, monocytes and granulocytes can be manipulated and together excluded from the analysis of lymphocytes by combining their marker signals into a single hybrid marker (CD14/CD15), which is simply (CD14+ OR CD15+).

TABLE 4

| | List file data | | | | |
|---|---|---|---|---|---|
| | Detector 1 | Detector 2 | Detector 3 | Detector 4 | Detector 5 |
| | marker | | | | |
| Events | CD3 | CD56 | CD19 | CD14 | CD15 |
| 1-990 | − | − | − | − | + |
| 991-999 | + | − | − | − | + |
| 1000-1049 | − | − | − | + | + |
| 1050-1099 | − | − | + | − | − |
| 1100-1149 | + | + | − | − | − |
| 1150-1199 | − | + | − | − | − |
| 1200-1400 | + | − | − | − | − |

The above-described strategies are the main “OR” gating strategies for CD56, CD3 and CD19 that can be combined with additional “NOT” gating for non-lymphocyte markers.

### Label/Reporter/Fluorescent Molecules

Antibody reagents according to the invention are represented by antibody molecules, which can recognize any antigens specific for particular cells. Non-limiting examples of such antibody reagents may be natural or recombinant full-length antibody molecules or antigen-binding fragments thereof specific for CD45, CD3, CD4, CD8 or the other antibody reagents discussed below.

Preferably, one or more of the antibody reagents are labelled with fluorescent reporter molecules, to enable the cell-binding agent and the cell to which it is bound, if any, to be identified and counted by flow cytometry analysis. Preferably, the microparticle counting beads are also labelled with a reporter molecule to enable counting.

Dyes having these properties may be selected from, but not limited to, the phycobiliproteins (especially phycoerythrin), fluorescein derivatives (such as fluorescein isothiocyanate), peridinin chlorophyll complex (such as described in U.S. Pat. No. 4,876,190), coumarin derivatives (such as aminomethyl coumarin), pthalocyanine dyes (such as Ultralite dyes (Ultradiagnostics)) and rhodamine derivatives (such as tetramethyl rhodamine or Texas Red (Molecular Probes)).

In some preferred embodiments fluorochromes may be selected from the group consisting of fluorescein isothiocyanate (FITC), phycoerythrin (PE), PE-Cy5, PE-Cy5.5, PE-Cy7, PE-A680, PE-TR (texas red), allophycocyanin (APC), APC-Cy7, Pacific Blue (PB), Cascade Yellow, Alexa dyes, coumarines or Q-dots.

Any one or more of these fluorochromes may be attached, preferably chemically conjugated, to the cell-binding agent such as an antibody or Major Histocompatibility Complex (MHC) molecule. Optionally, a fluorochrome (one or more than one) is disposed on or within the microparticle counting beads.

The majority of the fluorochromes may be conjugated with an antibody reagent by any method known in the art, e.g. reacting a maleimid-coupled fluorochrome with a thiolate-activated antibody, i.e. a chemoselective reaction, whereas FITC, Pacific Blue, Cascade Yellow, Cy5 and the Alexa dyes react directly with lysine amino-groups on the antibodies.

The reporter or “label” preferably comprises a light emitting detection means, and the light emitting detection means advantageously emits light of at least a fluorescent wavelength emission. It is preferred that the light emitting detection means comprises a fluorophore or fluorescent tag or group.

A “fluorescent tag” or “fluorescent group” refers to either a fluorophore or a fluorescent molecule or fluorescent protein or fluorescent fragment thereof. The fluorescent tag or group is such that it is capable of absorbing energy at a wavelength range and releasing energy at a wavelength range other than the absorbance range. The term “excitation wavelength” refers to the range of wavelengths at which a fluorophore absorbs energy. The term “emission wavelength” refers to the range of wavelength that the fluorophore releases energy or fluoresces. The term “fluorescent protein” refers to any protein which fluoresces when excited with appropriate electromagnetic radiation. This includes proteins whose amino acid sequences are either natural or engineered.

In some embodiments, the reporter label, preferably fluorescent tag, of the microparticle counting beads is different from that of the antibody and MHC molecule reagents. Preferably, the reporter labels are chosen such that the emission wavelength spectrum of one is distinguishable from the excitation wavelength spectrum of the other. The different reporter labels may be excitable by the same wavelength of light or different wavelengths. Preferably, the emission wavelengths are different. Alternatively, if the decay times of the excited species are different, time resolved fluorescence could be used.

In such an arrangement, it is possible to count the microparticle counting beads separately from the labeled reagents (i.e., the cells to which they are bound), for example, using a different fluorescent channel. However, while distinguishable reporter labels are preferred, it will be clear that this is not absolutely necessary. Indeed, in some embodiments, microparticle counting beads which are not labeled with fluorescent tags may be employed, while still being distinguishable from the labeled cells using other parameters. For example, the microparticle counting beads may be distinguishable form the labeled cells either by size (scatter parameters), emission wavelength (fluorescence parameters) or fluorescence intensity.

In one preferred embodiment the fluorochromes or fluorophores may comprise fluorescein and tetramethylrhodamine or another suitable pair. In another preferred embodiment, the label may comprise two different fluorescent proteins. Fluorescent protein may be selected from the group consisting of green fluorescent protein (GFP), blue fluorescent protein, red fluorescent protein and other engineered forms of GFP.

Preferably, the polypeptide comprises a cysteine or lysine amino acid through which the label is attached via a covalent bond.

A non-limiting list of chemical fluorophores and fluorochromes suitable for use, along with their excitation and emission wavelengths, is presented in Table 5 below.

TABLE 5
Excitation and emission wavelengths of
some fluorophores and fluorochromes

| Fluorophore | Excitation (nm) | Emission (nm) |
|---|---|---|
| PKH2 | 490 | 504 |
| PKH67 | 490 | 502 |
| Fluorescein (FITC) | 495 | 525 |
| Hoechst 33258 | 360 | 470 |
| R-Phycoerythrin (PE) | 488 | 578 |
| Rhodamine (TRITC) | 552 | 570 |
| Quantum Red | 488 | 670 |
| PKH26 | 551 | 567 |
| Texas Red | 596 | 620 |
| Cy3 | 552 | 570 |
| Pacific Blue (PB) | 410 | 455 |

Examples of fluorescent molecules which vary among themselves in excitation and emission maxima may be selected from the list of Table 1 of WO 97/28261 (incorporated herein by reference). These (each followed by [excitation max./emission max.] wavelengths expressed in nanometers) include wild-type Green Fluorescent Protein [395(475)/508] and the cloned mutant of Green Fluorescent Protein variants P4 [383/447], P4-3 [381/445], W7 [433(453)/475(501)], W2 [432(453)/480], S65T [489/511], P4-1 [504(396)/480], S65A [471/504], S65C [479/507], S65L [484/510], Y66F [360/442], Y66W [458/480], I0c [513/527], W1B [432(453)/476(503)], Emerald [487/508] and Sapphire [395/511]. This list is not exhaustive of fluorescent proteins known in the art; additional examples may be found in the Genbank and SwissProt public databases.

The fluorescence of the microparticle counting beads must be such that it is sufficiently greater than noise from background in one fluorescence channel so as to be distinguishable from the reporter molecules bound to the reagents, and it is also distinguishable in other fluorescence channel(s). The term “sufficient” refers to one log difference between the dye(s) and the microparticle fluorescence. The concentration of the microparticle counting beads should be greater than or equal to the number of cells to be counted. Generally, a final bead count of at least 1000 beads per μl is preferred.

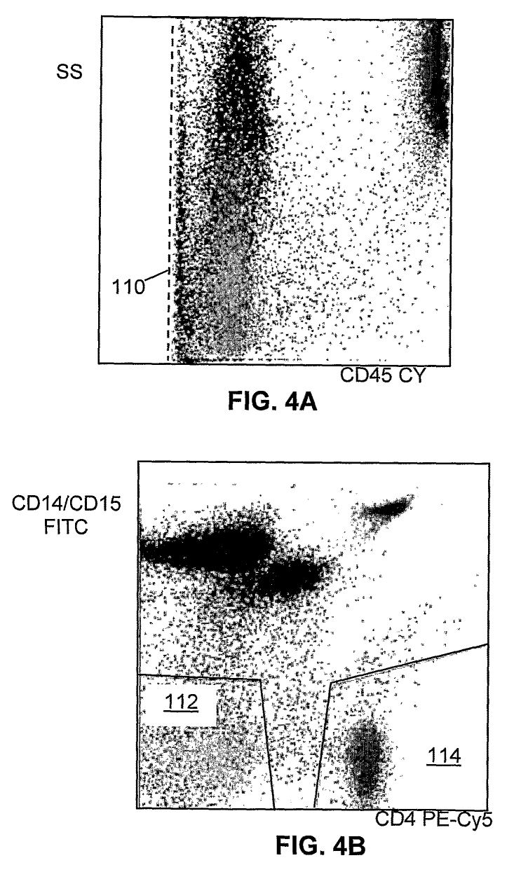

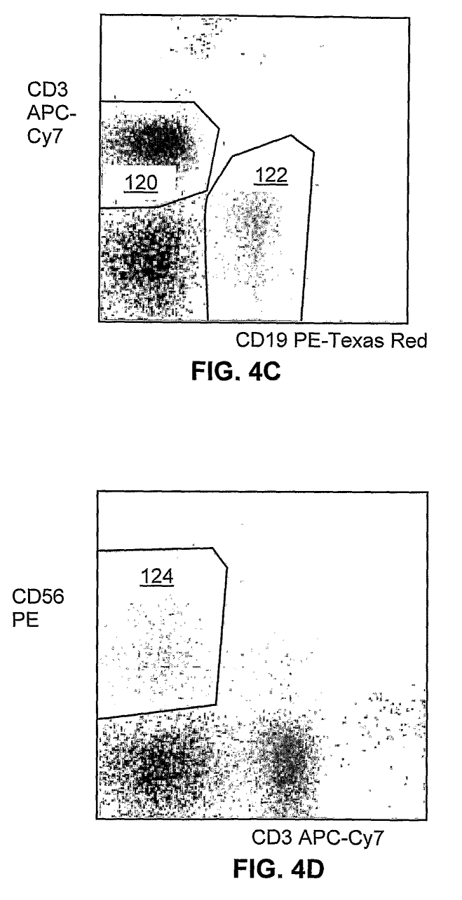

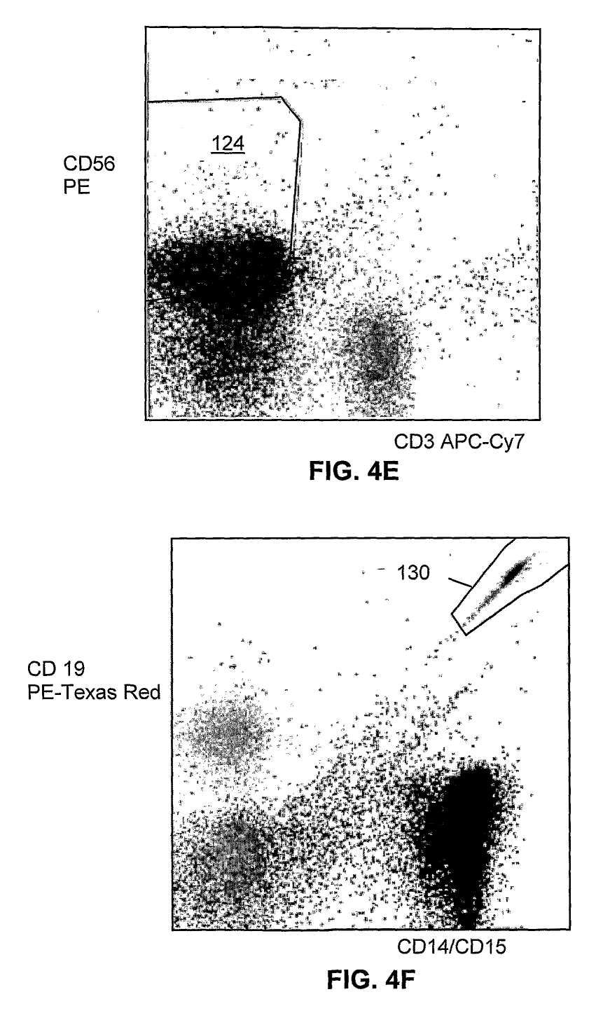

FIGS. 4A-4F are examples of a complete analysis of lymphocytes in an un-lysed blood sample, according to the invention. First, as shown in FIG. 4A, the signals from erythrocytes and platelets are electronically filtered out, during flow cytometry data collection, by setting an instrumental detection threshold (that is, an electronic trigger), represented as vertical line 110, for CD45. Any events for which the detected intensity of the CD45 fluorescent tag falls below the trigger (line 110) are discarded—no data is recorded for such events. The use of a trigger eliminates interfering instrumental and sample-related background, increases data acquisition speed and lowers the total number of events that are acquired. Although the use of the detected intensity of CD45 as a trigger is generally suitable for lymphocyte analyses, it may not be adequate in special cases. For instance, B cell malignancies show a loss of several surface antigen markers including CD45—one example is plasma cell diseases. However, this problem can be overcome by using another marker to generate the trigger signal. In advanced systems, it is even possible to use a trigger defined by an evaluation of a Boolean logical expression (either in data acquisition software or control electronics) that is based on or defined by multiple measured parameters and various Boolean logical operators. For example, for plasma cell analysis, one could use a Boolean trigger such as [CD45+ OR CD38_{bright} OR CD19+] to ensure that both the CD38_{bright} plasma cells (but often CD45_{dim} or negative) as well as normal B-cells (CD38− or CD38_{dim}, CD19+ and CD45+) in the sample are acquired. Another possibility would be to employ a plurality of triggers sequentially such that after a first threshold value is met or exceeded by a first measured parameter (e.g. FL1 intensity), at least a second independent threshold value relating to a different parameter must also be met or exceeded for triggering to occur.

Returning now to the discussion of FIG. 4A, it should be noted that the thin black “line” of dots on the left edge of the usable data (but to the right of trigger line 110, which is slightly offset from its correct position for readability) plotted in FIG. 4A results from some possible incomplete filtering of red blood cells and platelets as a result of the particular threshold adjustment. The next step in the analysis, as shown in FIG. 4B, is the exclusion of both monocytes and granulocytes using a gate relating to the (CD14/CD15) marker, as described above. FIG. 4B shows CD14/CD15-FITC plotted against CD4-PE-Cy5 for the data of FIG. 4A. In this type of plot, the granulocytes and monocytes plot as two distinct clusters towards the top of the diagram, whereas the lymphocytes plot as two groups on the lower left corner (region 112) and lower right corner (region 114) of the diagram. By selecting a gate, represented as the boundary lines of regions 112 and 114 in FIG. 4B, that surrounds the two lymphocyte clusters but excludes the monocytes, granulocytes and other events, the signals of the lymphocytes are purified in subsequent analyses.

FIGS. 4C-4D are plots of intensity distributions of events passing through (i.e., not excluded by) the monocyte/granulocyte exclusion gate of FIG. 4B. FIGS. 4C-4D are actually two dimensional projections of a three-dimensional data space defined by CD3, CD19, and CD56 fluorescence events. In the graph of FIG. 4C, showing CD19-PE-Texas Red fluorescence plotted versus CD3-APC-Cy7 fluorescence, the B-lymphocyte (region 122) and T-lymphocyte (region 120) populations are well defined, and therefore, gates are drawn around the clusters representing these populations, as shown. Likewise, the NK-lymphocyte population is well-defined in the graph of FIG. 4D, showing intensities of CD3-APC-Cy7 fluorescence plotted versus CD56-PE fluorescence and a gate (region 124) is drawn around the cluster representing the NK population. Other “noise” events, representing, in large part, residual red blood cell events not excluded by the initial instrument threshold, plot in the lower left-hand corners of both FIGS. 4C-4D. By summing the number of events included within the T-lymphocyte, B-lymphocyte and NK-lymphocyte gates, a measure of the total lymphocyte population, largely free from contaminating events from other cells, is thereby obtained.

FIG. 4E is an ungated plot of the same data shown in FIGS. 4A-4D, showing that the various cell populations overlap and cannot be separated from one another without the gating strategy defined above. FIG. 4F shows an extension of the method, in which a gate, region 130) may be defined for counting beads (added in known concentration to the un-lysed blood sample during preparation), so as to provide a single platform method for determining absolute lymphocyte count, per volume of blood. Many different types of plots or gates may be used to determine the bead counts, since the results for beads are generally seen as strongly positive emissions well segregated from the cell results in several different channels.

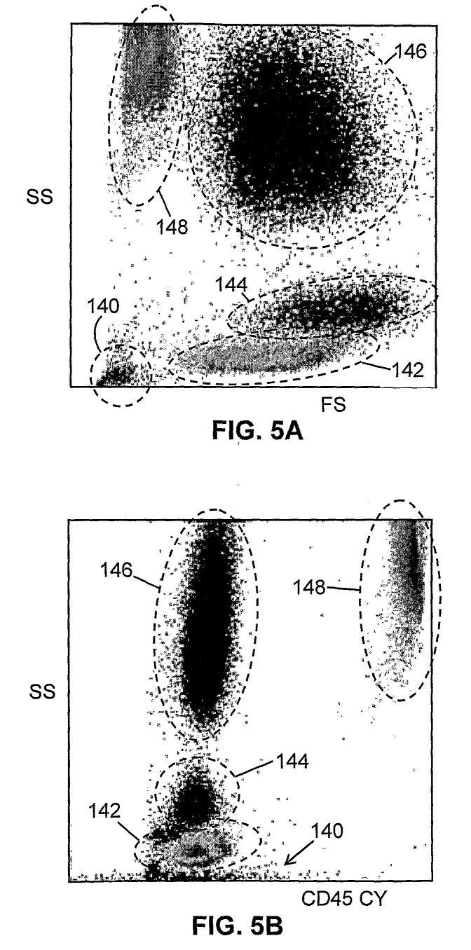

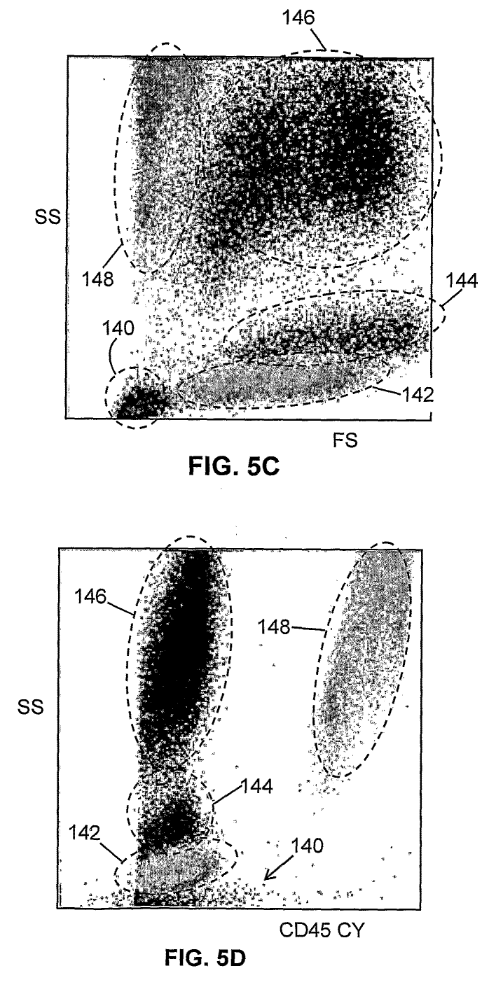

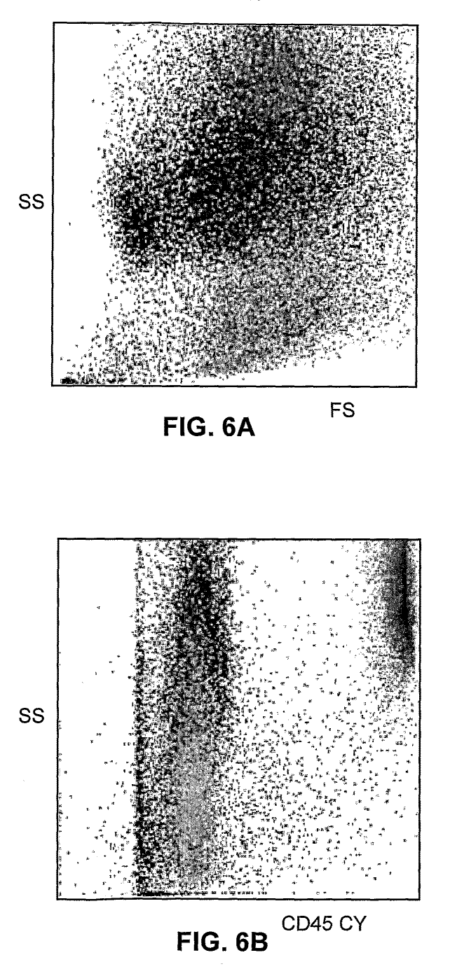

FIGS. 5-6 illustrate the distinct speed and throughput advantages of the methods of the present invention, as have been described above. The plots in FIGS. 5-6 show event plots from a cytometrically analyzed blood sample that include forward and side scatter at sample flow rates of 100 μl/min (FIGS. 5A-5B) and 300 μl/min (FIGS. 5C-5D) for a sample prepared according the Lyse/No wash method (FIG. 5) and at a sample flow rate of 100 gi/min using the No-Lyse method (FIGS. 6A=6B). The regions 140-148 shown in FIGS. 5A-5D enclose populations of cells that were identified using full gating analyses as outlined above. The inventors have found, as illustrated in FIGS. 5-6, that increasing sample flow rates tend to increase the spread of results obtained from optical scattering measurements. At higher sample flow rates (200 μl/min and greater), this increase in spread can be to such an extent that the results for the various cell populations overlap and merge, making it difficult or impossible to distinguish between them in data plots that include a scattering parameter. Although results based only on fluorescence from fluorescently tagged markers also exhibit some increased spread at higher flow rates, the inventors have determined that the increased spread is not so severe as to prevent distinguishing and separating the various white cell populations and sub-populations using methods according to the invention as described above.

The results shown in FIGS. 5-6 give rise to two conclusions. The first conclusion is that scattering parameters are not useful at all for No-Lysed blood samples and the gating techniques based purely on spectroscopic emissions from tagged markers must be employed for such samples. The second conclusion is that, even in lysed samples, there is an increase in the spread of the optical scatter results that can interfere with distinguishing between cell populations on the basis of scatter parameters. Although the exact physical mechanisms leading to the increased spread and overlap at high sample speeds are not known, it is to be kept in mind that, even in blood samples that have been subject to lysing procedures, the material previously belonging to red blood cells remains in the samples as small particulate debris. This debris is still available in the lysed samples to cause light scattering, although at diminished intensity or changed wavelength. Thus, there may be problematical background scattering at high sample flow rates even for lysed samples, and the purely spectroscopic (for instance, fluorescence) techniques described herein may be advantageously employed even for these un-lysed samples, when run at high sample flow rates. The inventors have determined that, using the methods of the present invention, there is no significant difference between lymphocyte counts as determined for lysed versus un-lysed samples.

Therefore, in summary, an exemplary methods for enumerating white blood cell counts in accordance with the invention may be outlined as follows:

### FIRST EXAMPLE

### Method 1

Step 1-1: Incubate a whole un-lysed blood sample with a first labelled agent, having a first label, that binds to a first marker, for instance, the CD56 marker, with a second labelled agent, having a second label, that binds to a second marker, for instance the CD3 marker and with a third labelled agent, having a third label, that binds to a third marker, for instance, the CD19 marker. Optionally, in this step, the sample may be incubated with at least a fourth labelled agent, binding to a fourth marker, for instance either the marker CD14 or CD15.
Step 1-2: Detect, in a flow cytometer, CD56+ cells, more generally, those cells that provide the spectroscopic signature of the first label; CD3+ cells, more generally, those cells that provide the spectroscopic signature of the second label and CD19+ cells, more generally, those cells that provide the spectroscopic signature of the third label. Optionally, within this detection step, the range of data detected may be instrumentally limited by setting a threshold (i.e., trigger), based on a scattering parameter, a detected spectroscopic signature or even on a Boolean logical expression that is based on or defined by multiple detected parameters and various Boolean logical operators, such that the records of events either exceeding or falling short of the threshold are discarded. Optionally, within this step, CD14+ cells and/or CD15+ cells may also be detected, more generally, those cells that provide the spectroscopic signature of at least a fourth label.
Step 1-3: Proceed to one of the alternative steps, Step 1-3A or Step 1-3B, as outlined below:
   Step 1-3A: In a flow cytometer sorter, purify a lymphocyte or other cell population by selectively separating, from other cells, those cells that are logically (CD56+ OR CD3+ OR CD19+), more generally, cells that provide a spectral signature of the first label, OR of the second label OR of the third label (not necessarily limited to just three labels). Alternatively, in this step the purified population may be limited by only including those cells that are negative for (do not provide the spectral signature of) at least the fourth label, e.g., cells that are either CD14− or CD15−.
   Step 1-3B: In data stored by a flow cytometer analyzer, determine the lymphocyte (or other cell type) count as the sum of the number of counts that are logically (CD56+ OR CD3+ OR CD19+), more generally, cells that provide a spectral signature of the first label OR of the second label OR of the third label (not necessarily limited to just three labels). Alternatively, in this step the count may be limited by subtracting from the count those cells that provide the spectral signature of the fourth label or of other labels, e.g. CD14, CD15 or both, or others.

An extension of this method would be to use a similar spectroscopic signature for two of the labels. One example of this is to have the same spectroscopic signature on the labels for CD15 and CD14. This approach would increase the efficiency by which the granulocytes and monocytes could be eliminated from the lymphocyte population: cells that are [CD56+ OR CD3+ OR CD19+NOT CD15 NOT CD14] would represent a more pure lymphocyte population but without the need for additional detectors on the instrument.

Either Step 1-1 may include the addition of a buffer solution or other diluent to the un-lysed whole blood sample, such as, for instance, phosphate buffered saline (PBS) solution. Generally, but not necessarily, the labelled agents described in Method 1 will be an antibody, such as a monoclonal antibody, conjugated to a fluorochrome, such as one of the fluorochromes listed in the first column of Table 5. A non-exhaustive list of examples of agents other than antibodies includes single molecule probes, antigen specific fragments of antibodies and engineered or synthesized proteins specifically designed to bind to particular target proteins.

Generally, but not necessarily, the spectroscopic signature described in Method 1 will be fluorescence of a fluorochrome of the labelled agent. Alternatively, the spectroscopic signature may include any known type of spectral signature, such as, for instance, fluorescence decay time, fluorescence lifetime, UV-visible optical absorption, infrared absorption, reflectance or emission, spontaneous, surface enhanced and resonance Raman scattering, etc. The portion of the labelled agent that provides the spectroscopic signature may include an isotope that modifies a spectroscopic profile in a particular fashion so as to produce a distinctive spectroscopic signature or that provides a radioactive emission that may be detected. The number of counts that are positive for a given marker (e.g, CD56+, CD3+ and CD19+) or for logical combinations (e.g. OR; AND; NOT) for other markers may be determined by statistical or graphic gating techniques, or combinations thereof, as are well-known in the art.

As described above, one possible extension of the above-disclosed strategies is to use the flow cytometer to get a full description of the percentages of each of the three major subsets of white blood cells: lymphocytes, monocytes and granulocytes. Debris is eliminated by gating the lymphocytes by the approach described above and then identifying the granulocytes with an appropriate set of markers such as [CD15+NOT CD14] whereas the monocytes can then be identified by another combination such as [CD14+NOT CD56+NOT CD3+NOT CD19+]. This would further allow for subtyping minor populations within each of these three major subsets with the previously added advantage of more purified (either after physical sorting or data sorting) populations. For instance, if a sub-population of the lymphocytes, such as CD4+ T-cells are simultaneously determined or counted, then it may be desired to report results as a ratio of CD4+ cells relative to lymphocytes, rather than providing an CD4+ absolute count. If this is done, then Step 1-1 may be accordingly modified through the addition of another labelled agent, having another label, that binds to the CD4+ marker. Also, Step 1-2 is accordingly modified so as to include detection and counting of the cells that are CD4+ by detecting the label of the agent that binds to CD4. By similar modifications, one can enumerate cells carrying any known cell marker or antigen to which specific agents (i.e., antigens) may bind.

The white blood cells counts determined by methods in accordance with the invention, such as Exemplary Method 1 above, may be converted to absolute counts (i.e., per volume) by any of the single-platform or dual-platform methods described in the Background section. For instance, if a single-platform method employing counting beads is employed, Step 1-1 may be accordingly modified through the addition of suitable counting beads (having their own particular distinctive spectral signature) in a known concentration to the whole blood sample or to the diluted whole blood sample. If this additional procedure is done, then Step 1-2 is accordingly modified so as to include detection and counting of the counting beads. Counting beads may be selected from fixed chicken red blood cells, coumarin beads, liposomes containing a fluorescent dye, fluorescein beads, rhodamine beads, fixed fluorescent cells, fluorescent cell nuclei, microorganisms and other beads tagged with a fluorescent dye. Other types of counting beads include microbeads, such as agarose beads, polyacrylamide beads, polystyrene beads, silica gel beads, etc.

Novel methods for high-speed flow cytometry quantification of biological cells in fluids or fluid suspensions has been disclosed. These methods have been illustrated, in particular, with reference to lymphocyte populations in un-lysed whole blood samples. However, the methods are also applicable, for instance, to high speed flow cytometric clinical screening for rare cell types, such as those indicative of Minimal Residual Disease. Another example to which the methods are applicable is the flow cytometric detection of Reed-Sternberg cells in relation to making diagnoses of Hodgkin's lymphoma.

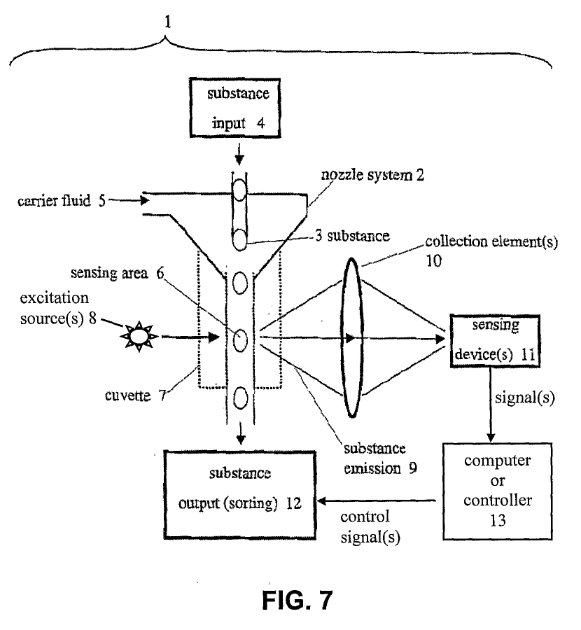

FIG. 7 illustrates a flow cytometer apparatus 1 for realization of embodiments of the present invention. The flow cytometer apparatus 1 may be a droplet flow cytometer, a continuous jet flow cytometer or a continuous fluid stream flow cytometer. The flow cytometer may be a flow cytometer analyzer, which counts cells of various types or characteristics, or a flow cytometer sorter, which physically separates cells or other particles into different sub-populations based on their characteristics. The flow cytometer 1 may include a nozzle or fluid flow system 1, which may be a cuvette, which may act to introduce a flow of substance 3 through substance input 4 within a carrier fluid 5. The substance and carrier fluids may be introduced through entry ports to the nozzle, cuvette or other fluid flow system from separate reservoirs. Using hydrodynamic focusing, the carrier fluid may be used to draw the substance into single file to permit measurement at the sensing area 6. The sensing area may be within a continuous stream, or cuvette 7 or the like through which, particle sensing can occur. Many flow cytometers utilize some type of external stimulus to interrogate the substance of interest so that a measurement of the property of that substance can be achieved. This stimulus may be electromagnetic radiation which illuminates the substance 3 in the carrier fluid, or alternatively, may be a naturally occurring process.

Accordingly, the substance 3 may be interrogated at the sensing area 6 by one or more excitation sources 8 of electromagnetic radiation or the like. Upon excitation, a subsequent substance emission 9 may be gathered from the sensing area 6 using collection elements 10 (e.g., collection optical elements) and transferred to one or more sensing devices 11 for detection and generation of one or more electronic or electrical signals that provide information on the substance emission properties from the particles or cells comprising the substance 3. The carrier fluid-substance mix may be processed or analyzed further, through measurement or sorting, or sent to waste through substance output or sorting region 12. Such processing or analysis may by a computer which receives the signals and may be achieved through specific software or programming on a computer 13. Each event relating to a detected particle or cell may give rise to a plurality of signals that are sensed by the sensing devices 11. These signals may relate, for instance to measured values of forward scattered or side scattered light from the particles or cells. They may also relate to fluorescent emissions at various wavelengths or wavelength bands. Generally, each such signal comprises a different respective independent parameter that relates to a different respective signal channel of the sensing devices or electronics. The channels that carry information on fluorescence at various wavelengths are often referred to as “fluorescence channels” and are respectively denoted as “FL1”, “FL2”, etc.

The computer 13 may process the signals, perhaps derived from a plurality of sensing devices 11, in order to provide data relating to the number (i.e., the count) and types of various particles or cells. In a flow cytometer sorter, the results of the processing or analyses may be used, in real time, to automatically make sort decisions for the particles or cells of the substance 3. Typically, the sorting is performed by applying an electrical charge to the fluid stream such that a specifically chosen last attached droplet acquires a known charge just prior to breaking off as a detached droplet. Based upon the acquired charge, the droplet may be deflected to a particular output as it passes through an electric field in the sorting region 12.

Further, complex gating strategies based on generalized and possibly nested Boolean logical expressions may be employed. Such Boolean logic expressions may utilize “exclusive or” (i.e., XOR) Boolean operators in addition to or instead of the AND, OR and NOT operators previously mentioned in this document. As a result of increases in computer processing speed, gating strategies using complex Boolean logic (various combinations of AND, OR NOT, XOR) can now be performed in software on a personal computer workstation 13 (see FIG. 7) electronically connected to a flow cytometer sorter. Such Boolean expressions may be pre-defined by a user, prior to beginning flow cytometer sorting. Subsequently, during sorting, the computer 13 may automatically evaluate the Boolean expression with reference to data from each particle that passes through the sensing area 6. Based on such evaluation, the computer may make a sorting decision for each particle in the time interval between when the particle passes through the sensing area 6 and when it reaches the sorting area 12. The computer then commands the flow cytometer sorter, via control signals as illustrated in FIG. 7, how to sort each particle (e.g, whether to sort the particle; in which direction to deflect the particle, if applicable; by how much to angularly deflect the particle, if applicable) based on the sorting decision for the particle. The data used in the evaluation may comprise information from multiple wavelengths of substance emission 9, perhaps produced by multiple fluorescent tags in the sample 3. Further, if the sort decision generating logic is implemented in software, a user can change the sort criteria—that is, the definition or logical form of the Boolean expression—at any time, either prior to sorting or even while a sorting operation is in progress.

As can be easily understood from the foregoing, the basic concepts of the present invention may be embodied in a variety of ways. The essence of the invention includes not only sample processing techniques but, also, the various systems, assemblies, and devices required or usable to accomplish the sample processing. Various modifications and variations of the described methods and system of the invention will be apparent to those skilled in the art without departing from the scope and spirit of the invention. Although the invention has been described in connection with specific preferred embodiments, it should be understood that the invention as claimed is not intended to be and should not be unduly limited to such specific embodiments. Indeed, various modifications of the described modes for carrying out the invention which are obvious to those skilled in diagnostic pathology, immunochemistry or related fields are intended to be within the scope of the claims.

1. A method for analyzing a pathological deviation of at least one white blood cell population from a normal level in an un-lysed blood sample, comprising:
counting, with a flow cytometer, a number, n₁, of white blood cells expressing a first marker;
counting, with the flow cytometer, a number, n₂, of white blood cells expressing a second marker;
counting, with the flow cytometer, a number, n₃, of white blood cells expressing a third marker and not expressing the first marker; and
comparing the sum (n₁+n₂+n₃) with a reference value.

2. The method of claim 1, wherein the white blood cells expressing the first marker, the second marker and the third marker are lymphocytes.

3. The method of claim 2, wherein the first marker is CD3, the second marker is CD19 and the third marker is CD56.

4. The method of claim 1, wherein at least 30,000 cells are interrogated per second.

5. The method of claim 1, wherein at least 40,000 cells are interrogated per second.

6. The method of claim 1, wherein a sample flow rate through the flow cytometer is at least 100 μl per minute.

7. The method of claim 1, wherein a sample flow rate through the flow cytometer is at least 200 μl per minute.

8. The method of claim 1, wherein a sample flow rate through the flow cytometer is at least 300 μl per minute.

9. The method of claim 1, wherein the counting is performed only on a subset of detected events, the subset comprising detected events that remain after elimination of background events, at the time of event sensing, by comparison of event data to a threshold.

10. The method of claim 9, wherein the threshold is based upon a signal intensity level relating to the marker CD45.

11. The method of claim 9, wherein the threshold is based upon evaluation of a Boolean logical expression, the evaluation utilizing at least two detected parameters.

12. The method of claim 11 wherein the Boolean logical expression is (CD45+ OR CD38_{bright} OR CD19+).

13. A method for analyzing a pathological deviation of at least one white blood cell population from a normal level in an un-lysed blood sample, comprising:
counting, with a flow cytometer, a number, n₁, of white blood cells expressing a first marker;
counting, with the flow cytometer, a number, n₂, of white blood cells expressing a second marker;
counting, with the flow cytometer, a number, n₃, of white blood cells expressing a third marker and not expressing the first marker;
counting, with the flow cytometer, at least one other number, no, each such other number being the number of white blood cells expressing a different respective marker, the set of all such other numbers being indexed as nₒᵢ, (4≦i≦N) for some maximum number N; and
comparing the quantity
$$( {n}_{1} + {n}_{2} + {n}_{3} - {{\sum }^{N}}_{4} {n}_{oi} )$$
with a reference value.

14. The method of claim 13, wherein the white blood cells expressing the first marker, the second marker, the third marker and each different respective marker are lymphocytes.

15. The method of claim 14, wherein the first marker is CD3, the second marker is CD19 and the third marker is CD56.

16. The method of claim 15, wherein each different respective marker is chosen from the group consisting of CD14 and CD15.

17. The method of claim 13, wherein at least 30,000 cells are interrogated per second.

18. The method of claim 13, wherein at least 40,000 cells are interrogated per second.

19. The method of claim 13, wherein a sample flow rate through the flow cytometer is at least 100 μl per minute.

20. The method of claim 13, wherein a sample flow rate through the flow cytometer is at least 200 μl per minute.

21. A single-platform method for analyzing a pathological deviation of the number of lymphocytes per liter from a normal level in an un-lysed blood sample, comprising:
counting, with a flow cytometer, a number, n₁, of cells expressing CD56 but not CD3;
counting, with the flow cytometer, a number, n₂, of cells expressing CD3;
counting, with the flow cytometer, a number, n₃, of cells expressing CD19;
counting, with the flow cytometer, a number, n₄, of counting beads;
calculating the number of lymphocytes counted as the sum of n₁, n₂ and n₃; and
correcting the number of lymphocytes counted to the number of lymphocytes per liter of blood using the measured number n₄ and a known concentration of the counting beads.

22. The single-platform method of claim 21, wherein the counting is performed only on a subset of detected events, the subset comprising detected events that remain after elimination of background events, at the time of event sensing, by comparison of event data to a threshold.

23. The single-platform method of claim 22, wherein the threshold is based upon a signal intensity level relating to the marker CD45.

24. The single-platform method of claim 22, wherein the threshold is based upon evaluation of a Boolean logical expression, the evaluation utilizing at least two detected parameters.

25. The single-platform method of claim 24 wherein the Boolean logical expression is (CD45+ OR CD38_{bright} OR CD19+).

26. A single-platform method for analyzing a pathological deviation of the number of lymphocytes per liter from a normal level in an un-lysed blood sample, comprising:
counting, with a flow cytometer, a number, n₁, of cells expressing CD56 but not CD3;
counting, with the flow cytometer, a number, n₂, of cells expressing CD3;
counting, with the flow cytometer, a number, n₃, of cells expressing CD19;
counting, with the flow cytometer, a number, n₄, of counting beads;
counting, with the flow cytometer, a number, n₅, of cells expressing CD14;
counting, with the flow cytometer, a number, n₆, of cells expressing CD15;
calculating the number of lymphocytes counted as the quantity (n₁+n₂+n₃)−(n₅+n₆); and
correcting the number of lymphocytes counted to the number of lymphocytes per liter of blood using the measured number n₄ and a known concentration of the counting beads.

27. The single-platform method of claim 26, wherein the counting is performed only on a subset of detected events, the subset comprising detected events that remain after elimination of background events, at the time of event sensing, by comparison of event data to a threshold.

28. The single-platform method of claim 27, wherein the threshold is based upon a signal intensity level relating to the marker CD45.

29. The single-platform method of claim 27, wherein the threshold is based upon evaluation of a Boolean logical expression, the evaluation utilizing at least two detected parameters.

30. The single-platform method of claim 29 wherein the Boolean logical expression is (CD45+ OR CD38_{bright} OR CD19+).

31. A system for sorting at least one white blood cell population from un-lysed blood sample to an output, comprising:
a flow cytometer sorter configured to derive data from emissions from each one of various individual blood cells of the sample, the data comprising:
a first data value relating to a first emission, the first emission relating to the presence of a first marker in the individual blood cell;
a second data value relating to a second emission, the second emission relating to the presence of a second marker in the individual blood cell; and
a third data value relating to the presence of a third emission, the third emission relating the presence of a third marker in the individual blood cell; and
a computer in communication with the flow cytometer sorter configured to receive the first, second and third data values, to evaluate a Boolean expression with reference to the first, second and third data values and to issue a sorting command to the flow cytometer based on the evaluation.

32. The system of claim 31, wherein the computer is adapted to receive the definition or logical form of the Boolean expression from a user prior to the sorting.

33. The system of claim 31, wherein the computer is adapted to receive a change in the definition or logical form of the Boolean expression from a user during the sorting.

34. A method for sorting at least one white blood cell population from un-lysed blood sample to an output, comprising:
providing a flow cytometer sorter configured to derive data from emissions from each one of various individual blood cells of the sample, the data comprising:
a first data value relating to a first emission, the first emission relating to the presence of a first marker in the individual blood cell;
a second data value relating to a second emission, the second emission relating to the presence of a second marker in the individual blood cell; and
a third data value relating to the presence of a third emission, the third emission relating the presence of a third marker in the individual blood cell; and
providing a computer in communication with the flow cytometer sorter configured to receive the first, second and third data values, to evaluate a Boolean expression with reference to the first, second and third data values and to issue a sorting command to the flow cytometer based on the evaluation.

35. The method of claim 34, wherein the computer is adapted to receive the definition or logical form of the Boolean expression from a user prior to the sorting.

36. The method of claim 34, wherein the computer is adapted to receive a change in the definition or logical form of the Boolean expression from a user during the sorting.
